(19) United States
(12) Patent Application Publication
(10) Pub. No.: US 2011/0235049 A1
(43) Pub. Date: Sep. 29, 2011

(54) Wavefront Sensing Method and Apparatus

(75) Inventors: James Gordon Burnett, Worcestershire (GB); Andrew Maxwell Scott, Worcestershire (GB); David Caradoc Jones, Worcestershire (GB); Simon Christopher Woods, Gloucestershire (GB)

(73) Assignee: QINETIQ LIMITED, Farnborough Hampshire (UK)

(21) Appl. No.: 13/131,252

(22) PCT Filed: Dec. 4, 2009
(86) PCT No.: PCT/GB09/02826

§ 371 Date: May 25, 2011

(30) Foreign Application Priority Data
Dec. 5, 2008 (GB) 0822247.3

(51) Int. Cl. G01B 9/02

(52) U.S. Cl. 356/484

(57) ABSTRACT

Wavefront sensing apparatus comprises a beam splitter (106) for combining a wavefront to be characterised (105) with a frequency-shifted plane wavefront (111) and a bundle of optical fibres (112) arranged to detect the combined beam at a plurality of positions across the combined beam. Output from individual fibres of the bundle are detected to produce corresponding heterodyne signals, the phases of which are extracted by demodulation. By fitting the extracted phases to an assumed functional form for the phase of the wavefront to be characterised, the piston, tip, tilt and radius of curvature phase parameters of the wave-front to be characterised may be found at the position of the fibre bundle. In contrast, prior art methods of wavefront characterisation only allow the piston phase of the wavefront to be characterised to be obtained.

The invention relates to the field of wavefront sensing, i.e. to methods of, and apparatus for, characterising wavefronts of electromagnetic radiation.

Wavefront sensing techniques have a variety of applications, for example in the accurate characterisation of surfaces by optical metrology and the correction of distorted wavefronts in the output beams of fibre-bundle lasers. In typical wavefront sensors of the prior art (see for example U.S. Pat. Nos. 6,229,616, 6,366,356) a beam having a wavefront to be characterised is combined with a frequency-shifted beam having a plane wavefront to produce a combined beam. By detection of the combined beam at a given position, a heterodyne signal is generated which has a phase corresponding to the phase of the wavefront to be characterised at that position. The phase of the heterodyne signal may then be extracted by a known phase-demodulation method. Detection of the combined beam at several positions thereacross allows more detailed wavefront characterisation.

The phase of the heterodyne signal generated by detection at a specific positions across the combined beam only yields the piston phase of the wavefront to be characterised at those specific positions. No other information about the wavefront to be characterised at those specific positions is obtained. However, in certain circumstances knowledge of other relative phase parameters of two wavefronts at various position is desirable, for example the relative tip, tilt and radius of curvature parameters.

U.S. Pat. No. 6,566,356, as mentioned above, is an example of a fibre-bundle laser system which outputs multiple beams side-by-side and utilises a wavefront sensor. A single measurement of phase is made for the beams output from each fibre of the fibre bundle. This is limited in that the wavefront sensor cannot detect the presence of tip, tilt and defocus errors of the individual beams. Such characteristics may be an unintended and undesirable consequence of manufacturing errors and can impact the performance of the fibre-bundle laser described.

U.S. Pat. No. 4,387,966 describes a method and apparatus for measuring deformation of a wavefront and in particular describes the use of heterodyne phase measurements at multiple positions across a wavefront to determine wavefront parameters. The method described obtains wavefront measurements of a single beam having low order wavefront aberrations and uses multiple detectors.

According to a first aspect of the invention, there is provided a method of wavefront sensing comprising the steps of
(i) combining first and second beams of radiation, said beams having a mutual frequency difference, to produce a combined beam;
(ii) detecting the combined beam at each of a plurality of positions thereacross to produce a corresponding plurality of heterodyne signals; and
(iii) measuring the phase of each of the heterodyne signals to provide corresponding phase measurements,
   wherein the method further comprises the step of determining relative tip and tilt phase parameters of the wavefronts of the first and second beams at one or more positions across the combined beam from the phase measurements.

The method may be a method of wavefront sensing of a fibre-bundle laser system. In some embodiments, the method may be carried out for at least two, or for each, output fibre of a fibre-bundle laser system. Such a method may further comprise determining the relative piston, tip and tilt phase parameters of an input beam having an input wavefront (or the piston, tip and tilt phase parameters of sections of the input beam), the fibre-bundle laser system being arranged to produce an output beam having an output wavefront, the method comprising controlling an actuation means associated with each output fibre in response to input of the determined relative phase parameters such that the form of the output wavefront tends to approach that of the input wavefront, or that of a wavefront having phase parameters differing by desired values from corresponding phase parameters of the input wavefront.

The method may comprise matching the output beam of an individual fibre of the fibre-bundle laser system to a portion of the input wavefront. The output beam of a single fibre in a fibre-bundle system may also be referred to as a ‘beamlet’ by the person skilled in the art.

The relative piston phase and radius of curvature phase parameters of the wavefronts of the first and second beams may also be determined. If the first beam has a plane wavefront, the piston, tip, tilt and radius of curvature parameters of the second wavefront may be determined by fitting the phase measurements to an assumed functional form for the phase of the second wavefront. This allows the phase of the wavefront of the second beam at any position to be calculated. In prior art techniques, only the piston phase is obtained for specific positions at which the combined beam is detected.

The positions at which the combined beam is detected may for example lie in a plane normal to the combined beam and having Cartesian coordinates (0, 0), (0,a), (a\sqrt{3}/2,−a/2) and (−a\sqrt{3}/2,−a/2) in said plane, where a is a constant and the position (0, 0) is the position of the centre of the combined beam. The combined beam may be detected by means of four optical fibres, each of diameter a and each having the core of an end-face located at one of these positions. The combined beam may be additionally detected at positions (0, −a), (a\sqrt{3}/2,a/2) and (−a\sqrt{3}/2,a/2) in said plane. Three further optical fibres of diameter a having end-faces at these positions may be used, resulting in a bundle of seven optical fibres having a central fibre surrounded by six peripheral fibres. This fibre bundle allows two simultaneous sets of positions across the combined beam to be detected, the first set of positions being (0, 0), (0,a), (a\sqrt{3}/2,−a/2) and (−a\sqrt{3}/2,−a/2) and the second set of positions being (0,0), (0, −a), (a\sqrt{3}/2,a/2) and (−a\sqrt{3}/2,a/2).

The combined beam may be detected serially at these positions, or alternatively, simultaneously.

Alternatively, the combined beam may be detected at a plurality of positions thereacross, by scanning the combined beam over a single fixed detedtion position. The heterodyne signal at a particular instant is then generated by detection of that part of the combined beam which is coincident with the fixed detection position at that instant. This allows a single detector to be used, rather than multiple detectors, to characterise the beam. In addition, scanning the beam may allow the entire combined beam to be substantially continuously monitored. This may provide additional information, when compared to the use of detectors which are static with respect to the combined beam, which may have ambiguities of 2π, 4π etc in the detected phase, which can lead to errors in a reconstructed wavefront.

The combined beam may be scanned over the fixed detection position either by reflecting it from a reflective element onto the fixed detection position and scanning the orientation of the reflective element, or by transmitting it through a pair of transparent, rotatable wedges which have orthogonal wedge angles.

The combined beam may be scanned over the fixed detection position using any one of a variety of scan patterns. One approach is to arrange for the combined beam to be scanned over the fixed detection position such that in a plane normal to the combined beam and containing the fixed detection position the Cartesian coordinates of the centre of the combined beam as a function of time have the form

$$x = \frac{r}{2} [ cos ( 2 π υ t ) + cos ( π - 2 π n υ t ) ] ;$$

$$y = \frac{r}{2} [ sin ( 2 πυ t ) + sin ( π - 2 π n υ t ) ]$$

x=0, y=0 being the position of the fixed detection position and n being an integer. With this scan pattern, the centre of the combined beam coincides with the fixed detection position six times per scan cycle, allowing frequent correction of tip, tilt and radius of curvature parameters caused by drift in the piston phase.

A second aspect of the invention provides wavefront-sensing apparatus comprising:
(i) means for combining first and second beams of radiation, said beams having a mutual frequency difference, to produce a combined beam;
(ii) detection means arranged to detect the combined beam at each of a plurality of positions thereacross and to produce a corresponding series of heterodyne signals; and
(iii) means for extracting the phase of each of the heterodyne signals to provide corresponding phase measurements;
   wherein the apparatus further comprises processing means arranged to determine relative tip and tilt phase parameters of the wavefronts of the first and second beams in response to input of the phase measurements. The processing means may be arranged to additionally determine the relative piston and radius of curvature phase parameters of the wavefronts. If the first beam has a plane wavefront, the processing means may be arranged to fit the phase measurements to an assumed functional form for the phase of the wavefront of the second beam as a function of position to determine the piston, tip, tilt and radius of curvature phase parameters of the wavefront of the second beam.

The wavefront-sensing apparatus may be a wavefront-sensing apparatus for a fibre-bundle laser system. The fibre-bundle laser system may comprise wavefront-sensing apparatus in conjunction with each fibre of the fibre-bundle (e.g. apparatus arranged to sense a combined beam output from each one of the plurality of fibres in the fibre-bundle laser system).

A third aspect of the invention provides a fibre-bundle laser system comprising
(i) a plurality of output optical fibres, each output optical fibre having an associated lens element arranged for transmission of radiation output therefrom; and
(ii) actuation means arranged to displace any given output optical fibre with respect to its associated lens element in a plane substantially normal to the direction of radiation output from the output optical fibre,
   wherein the laser system further comprises wavefront-sensing apparatus of the invention arranged determine the relative piston, tip and tilt phase parameters of a first beam having an input wavefront and a second beam having the output wavefront of the system and wherein the system further comprises a feedback loop to control the actuation means in response to input of the determined relative phase parameters such that in operation of the system the form of the output wavefront tends to approach that of the input wavefront, or that of a wavefront having phase parameters differing by desired values from corresponding phase parameters of the input wavefront.

The provision of a feedback loop and fibre actuators may provide a means to achieve self-alignment of the fibre-bundle laser array. This may be advantageous in various circumstances. For example, it may allow for correction of perturbations due to thermal heating at high power levels, mechanical distortions from vibration or acceleration drift due to aging, and/or to correct for manufacturing errors in fibre positioning. In some embodiments, this correction may be carried out automatically.

The fibre-bundle laser system may comprise wavefront sensing apparatus which in use of the system is arranged to sense the wavefront output from each output fibre of the fibre-bundle laser system.

Preferably the feedback loop incorporates means arranged to adjust the piston phases of the radiation output from the output optical fibres according to the relative piston phase parameter derived by the wavefront-sensing apparatus such that in use of the system the form of the output wavefront tends to approach that of the input wavefront. For example, means for stretching any given output optical fibre to increase its optical path length may be provided.

A fibre-bundle laser system of the invention allows the output wavefront of the system to be matched to an input wavefront. This is especially useful in delivering radiation through the atmosphere to a remote point of delivery with high efficiency, as is required in certain communication systems for example. In this case the input wavefront may be derived from light received from the remote point of delivery through the atmosphere. By matching the output wavefront of the laser system to the input wavefront, the output wavefront is pre-distorted such that on travelling through the atmosphere to the delivery point, the output wavefront of the laser system is substantially distortion-free at the delivery point. The number of output fibres in the system required to deliver a given amount of optical power to the remote delivery point is significantly reduced compared to a system having no wavefront correction, or wavefront correction wherein only the piston phase of the output wavefront is corrected.

Embodiments of the invention are described below by way of example only, and with reference to the accompanying drawings in which:

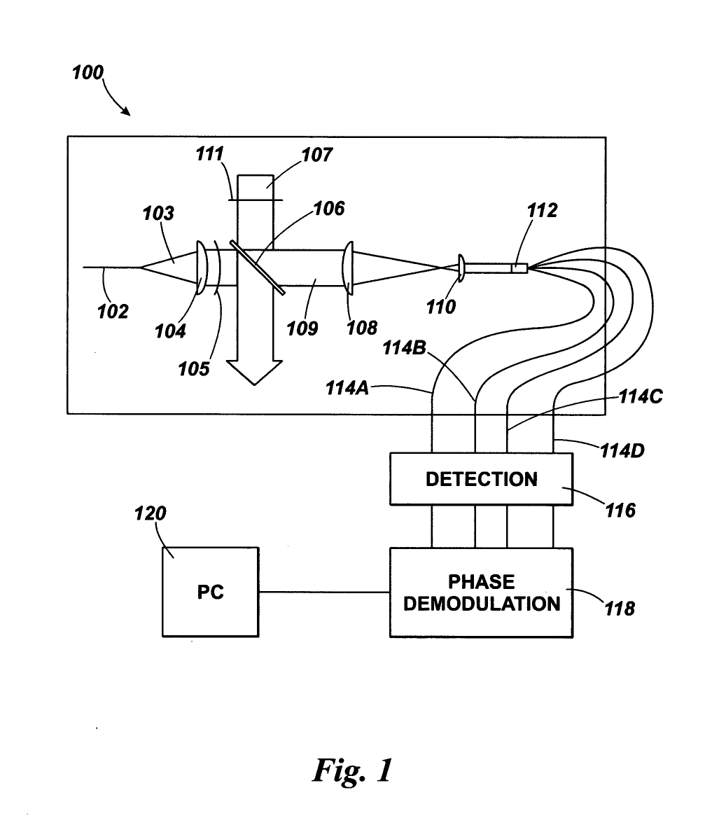

FIG. 1 shows a first example wavefront-sensing apparatus of the invention;

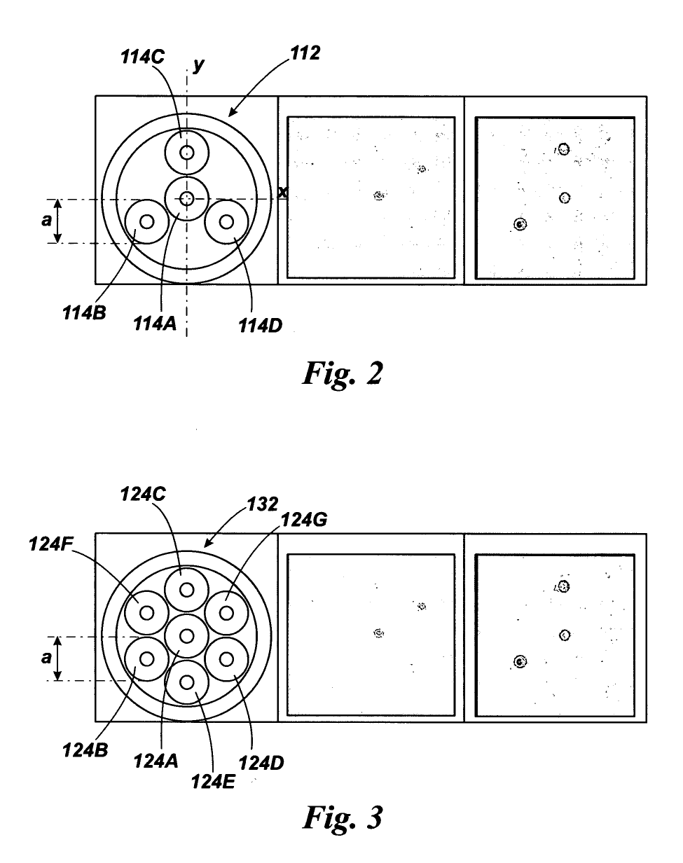

FIG. 2 shows a fibre-bundle arrangement used in the FIG. 1 apparatus;

FIG. 3 shows an alternative fibre-bundle arrangement which may be used in the FIG. 1 apparatus;

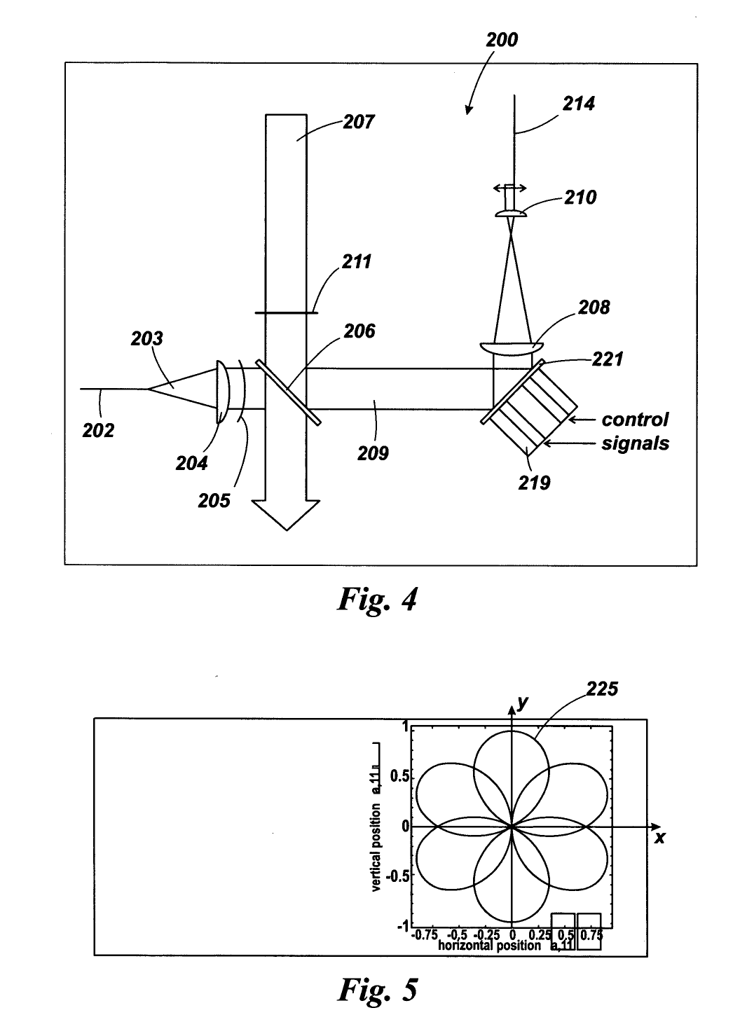

FIG. 4 shows a second example wavefront-sensing apparatus of the invention;

FIG. 5 illustrates one path that may be used to scan a beam in the FIG. 4 apparatus;

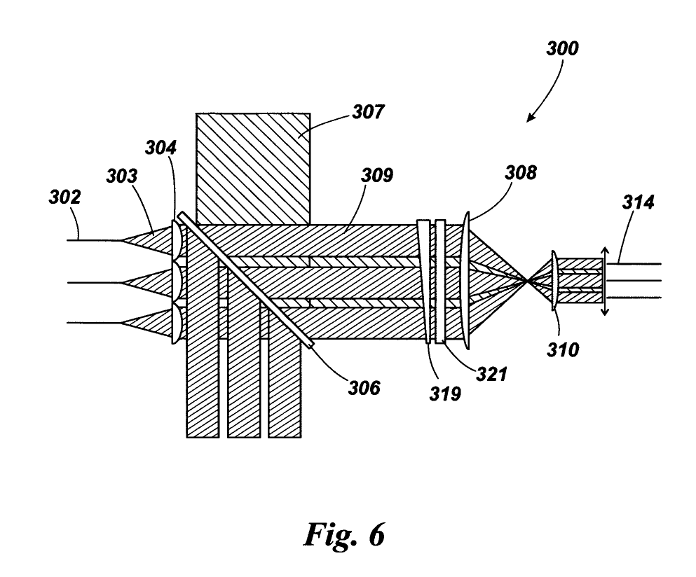

FIG. 6 shows a third example wavefront-sensing apparatus of the invention;

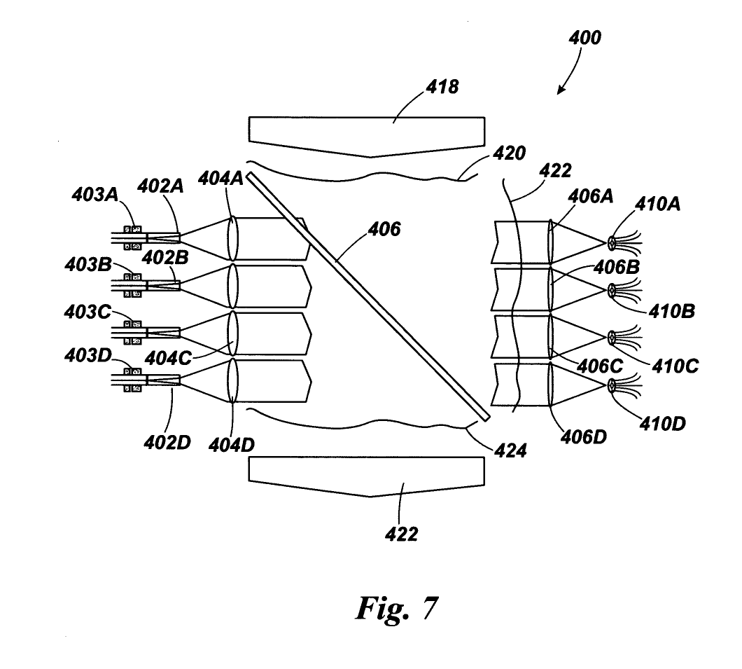

FIG. 7 shows a first example fibre-bundle laser system of the invention;

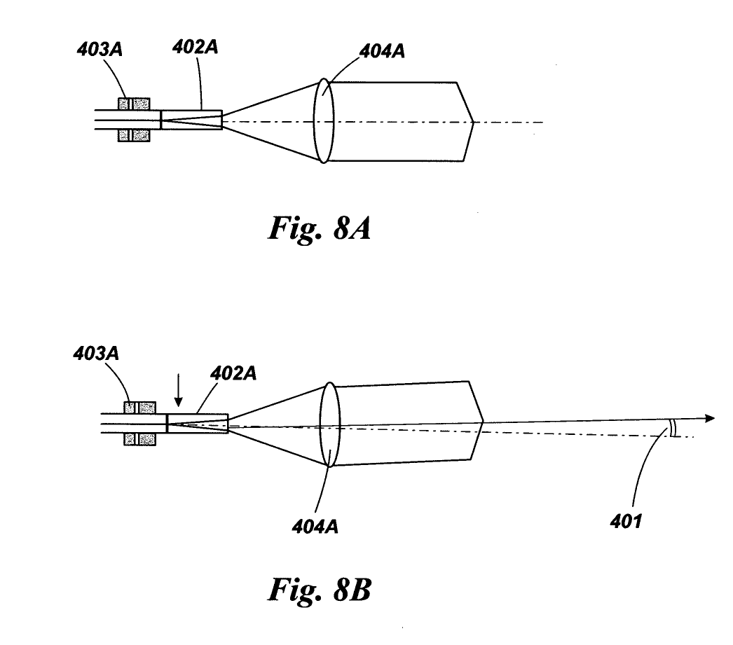

FIGS. 8A & 8B illustrate how the tip and tilt of a portion of the output wavefront of the FIG. 7 system may be adjusted; and

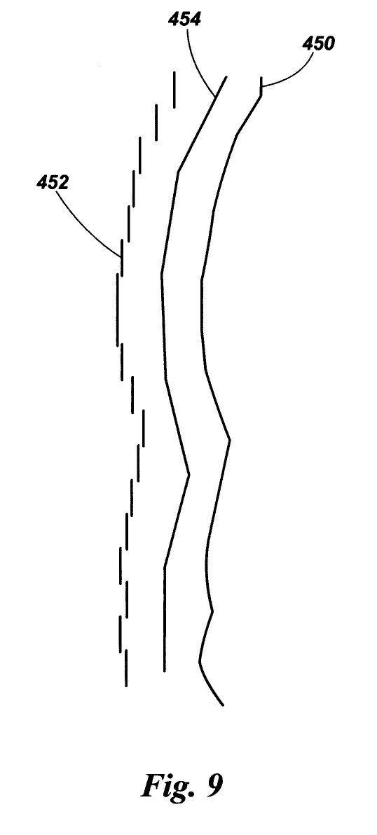

FIG. 9 shows a second example fibre-bundle laser system of the invention.

In FIG. 1, wavefront-sensing apparatus 100 of the invention comprises a beam splitter/recombiner 106, a telescope comprising lenses 108, 110 and a fibre-bundle 112 comprising four individual optical fibres 114A, 114B, 114C, 114D (for example Nufern® fibre having a 20 μm step-index core design, model PLMA YDF 20/400). Ends of the optical fibres 114A, 114B, 114C, 114D are coupled to photodiode detectors (not shown) in a detection unit 116. The outputs of the detectors are connected to a phase-demodulation unit 118 coupled to a personal computer (PC) 120.

Referring to FIG. 2, end faces of the optical fibres 114A, 114B, 114C, 114D remote from the detection unit 116 are arranged in the fibre-bundle 112 in a plane with fibre 114A centrally, and fibres 114B, 114C, 114D arranged around the fibre 114A such that the angle between adjacent straight lines in the plane joining the core of the optical fibre 114A to those of fibres 114B, 114C, 114D is 120°. In other words the relative Cartesian coordinates of the cores of the optical fibres 114A, 114B, 114C, 114D are (0, 0), (−a\sqrt{3}/2,−a/2), (0, a) and (a\sqrt{3}/2,−a/2) respectively, where a is the diameter of optical fibre employed.

In use of the apparatus 100, a beam 103 from an input optical fibre 102 having a wavefront 105 to be characterised is combined with a beam 107 having a plane (or other) wavefront 111 at the beam splitter/recombiner 106 to produce a combined beam 109 which passes to the fibre-bundle 112 via telescope lenses 108, 110. Telescope lenses 108, 110 of the telescope have focal lengths and a relative separation such that the diameter of the combined beam 109 at the fibre-bundle 112 is considerably larger than the diameter of the fibre-bundle 112. The combined beam is sampled by the four optical fibres 114A, 114B, 114C, 114D. Detection by the detection unit 116 of radiation output from the optical fibres 114A-D at the ends thereof remote from the bundle 112 generates four corresponding heterodyne signals, the phases of which correspond to the phase of the wavefront to be characterised at the positions of the cores of the four optical fibres 114A, 114B, 114C, 114D. The fibres 114A-D therefore provide sensing or detecting fibres and the fibre-bundle 112 provides a sensing or detecting fibre bundle.

Generally, in the following description, the light emitted from the apparatus as a whole, as well as the light emitted from individual fibres, is referred to as a ‘beam’. As will be appreciated by the skilled person, ‘beams’ emitted from individual fibres of a fibre bundle are sometimes alternatively termed ‘beamlets’.

The phase demodulation unit 118 comprises standard components (for example Mini-Circuits® ZFMIQ-70D) arranged to produce an I, Q output in response to input of each of the four heterodyne signals output from the detection unit 116. The I, Q outputs (Iⱼ, Qⱼ, j=0, 1, 2, 3) are related to the phases φ₀, φ₁, φ₂, φ₃ of the wavefront to be characterised at the positions of the cores of the optical fibres 114A, 114B, 114C, 114D as follows:

$${φ}_{0} = arg ( \frac{{I}_{0}}{{Q}_{0}} ) + 2 m π \\ {φ}_{1} = arg ( \frac{{I}_{1}}{{Q}_{1}} ) + 2 n π \\ {φ}_{2} = arg ( \frac{{I}_{2}}{{Q}_{2}} ) + 2 o π \\ {φ}_{3} = arg ( \frac{{I}_{3}}{{Q}_{3}} ) + 3 p π , \qquad ( 1 )$$

where m, n, o, p are integers. The I, Q outputs from the demodulation unit 118 are digitised using a data acquisition PCI card (e.g. National Instruments® NI-PCI-6229) installed in the PC 120 and processed by the PC 120 to obtain piston, tip, tilt and radius of curvature parameters for the wavefront to be characterised.

The height z(x, y) of the wavefront to be characterised above the plane of the fibre-bundle 112, as a function of position (x, y) in that plane with respect to the core of the optical fibre 114A, can be approximated by

$$z ( x , y ) = {z}_{0} + {θ}_{x} x + {θ}_{y} y + \frac{{x}^{2} + {y}^{2}}{2 R} \qquad ( 2 )$$

where θₓ and θ_{y} are the inclinations of the wavefront in the horizontal and vertical planes respectively, R its radius of curvature (or focus parameter), and z₀ its piston phase. The horizontal plane is the plane of FIG. 1 and the vertical plane is the plane perpendicular to the plane of FIG. 1. θₓ and θ_{y} are the ‘tip’ and ‘tilt’ parameters of the wavefront to be characterised.

If the phases of the heterodyne signals resulting from detection of radiation output from the optical fibres 114A, 114B, 114C, 114D are respectively φ₀, φ₁, φ₂, φ₃, then from (1) and the coordinates of the fibres it follows that

φ₀=z₀/λ

φ₁=z₀/λ+aθₓ/λ

φ₂=z₀/λ+\sqrt{3}aθₓ/2λ−aθ_{y}/2λ

φ₃=z₀/λ−\sqrt{3}aθₓ/2λ−aθ_{y}/2λ (3)

The piston, tip, tilt and focus parameters are therefore

$$piston \text{:} \frac{{z}_{0}}{λ} = {φ}_{0} \\ tip \text{:} {θ}_{x} = \frac{λ}{\sqrt{3} a} ( {φ}_{2} - {φ}_{3} ) \\ tilt \text{:} {θ}_{y} = \frac{2 λ}{3 a} [ {φ}_{1} - ( \frac{{φ}_{2} - {φ}_{3}}{2} ) ] \\ focus \text{:} \frac{1}{R} = \frac{2 λ}{{a}^{2}} [ ( \frac{{φ}_{1} + {φ}_{2} + {φ}_{3}}{3} ) - {φ}_{0} ] \qquad ( 4 )$$

The wavefront parameters may therefore be obtained from knowledge of the phases φ₀, φ₁, φ₂, φ₃ of the heterodyne signals, or equivalently, from the I, Q outputs from the demodulation unit 118.

The PC 120 runs software for obtaining the phase values φ₀, φ₁, φ₂, φ₃ from the digitised I, Q outputs input to it from the demodulation unit 118 and for calculating the piston, tip, tilt and focus parameters therefrom. For example, National Instruments® LabVIEW® software may be used for this purpose, allowing real-time calculation and tracking of the phase-parameters.

Typically, the piston phase z₀ varies rapidly with time due to phase noise and optical path length drift, and the integers m, n, o, p therefore increment and decrement rapidly and at different times as the phase values φ₀, φ₁, φ₂, φ₃ cross the negative I axis. This can lead to difficulties in deriving unwrapped phase values. To overcome this problem, the PC 120 is arranged to perform a coordinate rotation such that new I, Q values I′ⱼ, Q′ⱼ, j=0, 1, 2, 3 are calculated according to the transformation:

I′ⱼ=Iⱼ cos (α)+Qⱼ sin (α)

Q′ⱼ=Qⱼ cos (α)−Iⱼ sin (α) (5),

where α=arg(I₀/Q₀). The phases φ₁, φ₂, φ₃ are obtained in the new coordinates. The coordinate transformation means that φ₁, φ₂, φ₃ change only in response to changes in the shape of the wavefront to be characterised and not to changes in piston phase z₀. The phases φ₁, φ₂, φ₃ in (1) above in the new coordinate system may then be robustly tracked, and unwrapped using standard phase-unwrapping techniques.

FIG. 3 show an alternative fibre bundle 132 that may be used in the apparatus 100 in place of the fibre-bundle 112. The bundle comprises seven optical fibres 124A-G, each of diameter a. Fibres 124A-D have relative coordinates (0, 0), (−a\sqrt{3}/2,−a/2), (0, a) and (a\sqrt{3}/2,−a/2). Fibres 124E, 124F and 124G have relative coordinates (−a\sqrt{3}/2a/2), (0, −a) and (a\sqrt{3}/2,a/2). Use of the fibre-bundle 132 provides for two simultaneous sets of calculations for the wavefront parameters to be performed, one set using heterodyne signals generated from detection of the outputs of optical fibres 124A-D, and the other using heterodyne signals generated using the outputs of optical fibres 124A and 124E-G.

FIG. 4 shows another wavefront sensing apparatus 200 of the invention; components corresponding to components in the apparatus 100 of FIG. 1 are labelled with reference signs differing by a value of 100 from those labelling the corresponding components in FIG. 1.

In operation of the apparatus 200, a beam 203 having a wavefront 205 to be characterised is combined with a reference beam 207 having a plane (or other) wavefront 211 at a beam-splitter/recombiner 206 to produce a combined beam 209 which passes to a single detecting optical fibre 214 via mirror 221 having a controllable orientation and telescope lenses 208, 210. Control means (not shown) scan the orientation of the mirror 221 such that the combined beam 209 is scanned over the detecting optical fibre 214 (e.g. Nufern® model PLMA YDF 20/400). The focal lengths and relative separation of the telescope lenses 208, 210 are chosen such that the diameter of the combined beam at the detecting optical fibre 214 is considerably larger than the diameter of the fibre 214. Output from the detecting optical fibre 214 is detected by a photodiode (not shown), the output of which is connected a phase-demodulation unit coupled to a PC (not shown) which is arranged to record phase-values as the mirror 221 is scanned in orientation.

The orientation of the mirror 221 is scanned such that the relative position of the core of the detecting optical fibre 214 with respect to the centre of the combined beam 109 as a function of time follows a scan path, indicated by 225 in FIG. 5, having Cartesian coordinates in the plane normal to the direction of the combined beam 209 at the fibre 214 given by

$$x = \frac{r}{2} [ cos ( 2 π υ t ) + cos ( π - 2 π n υ t ) ] \\ y = \frac{r}{2} [ sin ( 2 πυ t ) + sin ( π - 2 π n υ t ) ] \qquad ( 6 )$$

Other scan patterns may be used in alternative embodiments of the invention.

The scan path 225 allows sampling over much of the cross-section of the combined beam without sudden changes in the orientation of the mirror 221. The scan path 225 begins and ends with relative position of the detecting optical fibre 214 coincident with the centre of the combined beam, and has several returns through this position during execution of scan path. This allows any drift in piston phase to be monitored and corrected for if required.

In operation of the apparatus 200, the phase of the heterodyne signal output by the photodiode in response to radiation incident on it from the detecting optical fibre 214 corresponds to the phase of that part of the wavefront to be characterised which is incident on the detecting optical fibre 214 at that instant. The phase of the wavefront to be characterised is sampled at multiple positions serially by the PC, rather than at several positions simultaneously, as is the case with the apparatus 100 of FIG. 1.

The heterodyne signal output by the photodiode is phase-demodulated (e.g. Mini-Circuits® ZFMIQ-70D) and the extracted phase unwrapped by standard techniques as indicated above. Assuming the height of the wavefront to be characterised with respect to the detecting optical fibre 214 has the form in (2) above, then using (6) the phase of the heterodyne signal output by the photodiode as a function of time is given by

$$φ ( t ) \begin{matrix}= \frac{z}{λ} \\ = \frac{{z}_{0}}{λ} + \frac{r {θ}_{x}}{2} [ cos ( 2 π υ t ) - cos ( 10 π υ t ) ] + \\ \frac{r {θ}_{y}}{2} [ sin ( 2 π υ t ) + sin ( 10 π υ t ) ] + \\ \frac{{r}^{2}}{8 R} \{ \begin{matrix}{[ cos ( 2 π υ t ) - cos ( 10 π υ t ) ]}^{2} + \\ {[ sin ( 2 π υ t ) + sin ( 10 π υ t ) ]}^{2}\end{matrix} \}\end{matrix} \qquad ( 7 )$$

The PC is arranged to obtain the piston, tip, tilt and phase parameters by performing a 1D curve fit to recorded phase values using the Levenberg Marquardt method.

In order to scan the orientation of the mirror 221, the control means applies first and second control voltages V₁, V₂ to an actuator mounting the mirror 221. Voltages V₁, V₂ control the orientation of the mirror 221 in planes parallel and perpendicular to the plane of FIG. 4, respectively. As an example, in the case of the Physik Instrumente model S-334 ultra-long range piezo tip/tilt mirror, the control voltages required to provide a relative displacement (x, y) of the detecting optical fibre 214 from the centre of the combined beam 209 are

$${V}_{1} = \frac{y}{\sqrt{2} kd} cos α - \frac{x}{2 kd} sin α \\ {V}_{2} = \frac{x}{2 kd} cos α + \frac{y}{\sqrt{2} kd} sin α \qquad ( 8 )$$

where d is the distance from lens 204 to the mirror 221, k is a constant relating control voltage to mirror rotation angle and α is a constant angular offset which has been measured as approximately 52°.

FIG. 6 shows another wavefront sensing apparatus 300 of the invention in which a combined beam 309 passes through a pair of transparent, rotatable wedges and telescope lenses 308, 310 prior to detection at a detecting optical fibre 314. The wedges 319, 321 have mutually orthogonal wedges angles such that when rotated the combined beam is scanned over the detection fibre 314. The optical output of the detection fibre 314 is detected at a photodetector (not shown) to generate a heterodyne signal the phase of which is extracted by a phase-demodulation unit (not shown). A PC (not shown) digitises and records the resulting I, Q signals and evaluates the piston, tip, tilt and phase parameters of the wavefront to be characterised in the general manner described above in relation to the apparatus 200 of FIG. 4.

FIG. 7 shows a fibre-bundle laser system 400 incorporating wavefront sensors of the invention. The system 400 comprises four lasers (not shown) each of which is coupled to a respective optical fibre 402. (Alternatively output from a single laser may be divided between the four fibres 402.) The optical output from each fibre 402 is collimated by a respective collimating lens 404. Each optical fibre 402 is mounted in a respective actuator 403 which allows the end of a fibre 402 to be displaced in a plane perpendicular to the plane of FIG. 7. The system 400 further comprises stretching means (not shown) for stretching each of the fibres 403. The majority of the output from the fibres 402 is reflected from a beam splitter/recombiner 406 as output 422 of the system 400 having a wavefront 424. A small proportion of the optical power output from the fibres 402 passes through the beam-splitter/recombiner 406 and has a wavefront 422 substantially identical to the wavefront 424. Portions of the outputs from the fibres 402A, 402B, 402C, 402D transmitted by the beam-splitter/recombiner 406 are partially focussed onto respective detecting fibre-bundles 410A, 410B, 410C, 410D by respective lenses 406A, 406B, 406C, 406D. Each of the fibre-bundles 410 comprises four individual optical fibres having the arrangement shown in FIG. 2.

In operation of the system 400, a (relatively low-power) optical input 418 which is frequency-shifted with respect to the output from the fibres 402, and which has a wavefront 420 which it is desired to impress on the (relatively high-power) output 422 of the system 400 forms a first input to the beam-splitter/recombiner 406. Output from the optical fibres 402 forms a second input. The first and second inputs form a combined beam, sections of which are partially focussed by lenses 406 onto corresponding detecting fibre-bundles 410A-D.

The four individual outputs from a given detecting fibre-bundle 410 are detected by individual photodetectors (not shown) and are processed as explained above in relation to the apparatus 100 of FIG. 1 to obtain a set of phase parameters characterising the phase difference between sections of the input wavefront 420 and the wavefront 424 corresponding to that detecting fibre-bundle. The phase parameters derived from optical signals detected by a given detecting fibre-bundle 410 are used in a feedback loop to provide control signals to the stretching means and actuator 403 corresponding to that detecting fibre-bundle to minimise the difference between the phase parameters of wavefronts 420 and 424. For example, phase parameters obtained by processing the outputs of the fibre-bundle 410A indicate differences in the piston, tip, tilt and phase parameters between the wavefront output from the fibre 402A and that portion of the wavefront 420 with which it is combined by the beam-splitter/recombiner 406. The phase parameters are used in a feedback loop to provide control signal to the actuator 403A and the stretching means associated with the fibre 402A to control the piston, tip and tilt phase parameters of the output of fibre 402A so that they approach those of that portion of the wavefront 420 which overlaps with the output of fibre 402A at the detecting fibre-bundle 410A.

It will be noted that, in the embodiment described above, there are as many detecting fibre bundles 410 as there are fibres in the fibre-bundle laser system 400. In the example described above, each fibre 410A-D of each wavefront sensing fibre bundles 410 is associated with an individual photodetector. This allows piston, tip and tilt wavefront phase information for each of the fibres of the fibre-bundle laser system 400 to be obtained (if there was only a single static photodetector, only the piston phase could be obtained). If alternative wavefront sensing apparatus was used (for example, the scanning wavefront sensing apparatus 200, 300 shown in FIGS. 4 and 6), this complete wavefront phase information could be derived with a single detector in association with each fibre of the fibre-bundle laser system 400.

FIGS. 8A and FIG. 8B indicate how displacement of the fibre 402A with respect to the fixed collimating lens 404A by the actuator 403A in the plane of those figures allows direction of the output of the fibre 402A to be adjusted in the plane of the figures. Adjustment in the plane perpendicular to the plane of FIGS. 8A and 8B may also be achieved.

Control signals generated from detection and processing of the outputs of the fibre-bundles 410 are fed back to the stretching means and actuators 403 so that the piston, tip and tilt parameters of the sections of wavefront 424 generated by the outputs of fibres 402 approach those of the corresponding sections of the input wavefront 420. When the system 400 operates in a steady state, the output wavefront 424 has the same phase profile as that of the input wavefront 420.

FIG. 9 illustrates how adjusting sections of a plane wavefront for tip and tilt phase parameters, in addition to adjusting the piston phases of the sections, results in a more accurate replication of an input wavefront. An input wavefront to be input to the system 400 of FIG. 7 and which is required to be replicated as the output wavefront is indicated by 450. If only the piston phases of the output wavefronts from the optical fibres 402 are adjusted to conform to the piston phases of corresponding sections of the wavefront 450, the output wavefront of the system 400 may be approximated by the wavefront 452. By adjusting the tip and tilt parameters of the outputs of the fibres 402, the output wavefront of the system 400 may be adjusted to the wavefront 454, which more closely represents the input wavefront 450.

In summary, in this example, the input wavefront 450 is a continuous wavefront which is to be replicated as closely as possible by the fibre bundle laser system 400. It is measured by the wavefront sensing system and the information is used to drive the output of the fibre bundle laser system 400 such that its output approximates that of the input as closely as possible.

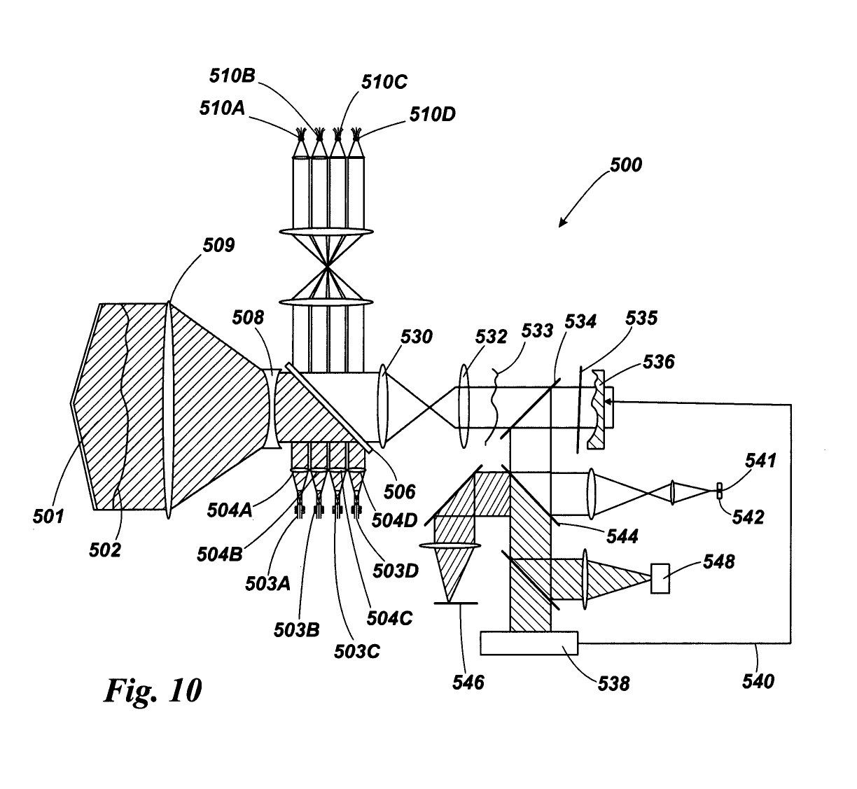

FIG. 10 shows another fibre-bundle laser system 500 of the invention which also incorporates a wavefront sensor of the invention. The system 500 comprises output optical fibres 503A-D each coupled to a respective laser (not shown). Outputs from the outputs fibres 503A-D are collimated by respective lenses 504A-D. In operation of the system 500, the majority of the power output from the fibre 503A-D is reflected by a beam-splitter 506 and the combined output of the fibres 503A-D is expanded by a telescope 508, 509 to provide output 501 having an output wavefront 502 for transmission through the atmosphere to a remote delivery point. The output fibres 503A-D are each mounted on a respective actuator allowing the ends of the fibres 503A-D to be displaced in a plane perpendicular to the plane of the figure. Means (not shown) are also provided for stretching the output optical fibres 503A-D. In a similar manner to that explained above with reference to FIG. 9, the output wavefront 502 of output beam 501 is adapted to closely correspond to that of an input wavefront received from the remote scene.

In operation of the system 500, the diameter of an input radiation beam from the remote scene is reduced by a second telescope 530, 532 and the input radiation passes through a polarising beam splitter 534 and a quarter-wave plate 535 and is incident on a deformable mirror 536. After being reflected from the deformable mirror 536 and passing through the quarter-wave plate 535 a first portion of the input radiation is reflected by the polarising beam-splitter 534 to a wavefront sensor 538 which is used to control the form of the reflecting surface of the deformable mirror 536 by means of a feedback loop indicated by 540. A second portion of the input radiation reflected from the deformable mirror 536 passes back through the polarising beam splitter 534, telescope 532, 530 and is directed to a wavefront sensor comprising four fibre-bundles 510A-D each having the form shown in FIG. 2.

The feedback loop 540 operates (in the steady state) to control the deformable mirror 536 such that on reflection therefrom an input wavefront from the scene is converted into a plane wavefront. Light from a fibre-coupled laser 541 passes to the deformable mirror 536 via beam-splitters 534, 544 and on reflection from the deformable mirror 536 has a wavefront equivalent to that of light received from the remote scene. The light from this fibre coupled laser 541 is relatively low power when compared to the output of the fibre-bundle laser system 500. The deformable mirror 536 reflects this light (and a portion of light from the scene) but it will be noted that the light from the fibre-bundle laser system 500 is not incident on the deformable mirror 536. This therefore provides a means to lock the wavefront of a high power beam to a low power beam without having to use a deformable mirror with high power handling capability. This light is frequency-shifted from that of the output of the system 500. A typical frequency shift might be, as in this embodiment, approximately 80 MHz.

The reflected light passes via telescope 530, 532 and beam-splitter 506 to fibre-bundles 510A-D. The outputs of each of the fibre-bundles 510A-D are used to extract piston, tip and tilt phase parameters of corresponding sections of the input wavefront as explained above in relation to the sensor 100 of FIG. 1. A feedback loop (not shown) applies control signals to the actuators mounting the fibres 504A-D and to the means for stretching the fibres 504A-D in response to input of the phase parameters such that the output wavefront generated by the fibres 504A-D approaches the input wavefront from the remote delivery point. In the steady state the input and output wavefronts are substantially identical.

A portion of the output of the fibre-coupled laser 541 is transmitted by beam-splitter 544 and focussed onto a phosphorescent screen 546 where it produces a spot indicating the direction of the output 501 of the system 500. An image of the phosphorescent spot is formed at a camera 548. The actuator 542 is adjusted so that the image of the phosphorescent spot coincides with the image of the remote delivery point. When these two images coincide at the camera 548, the output 501 of the system 500 is directed, with compensation for atmospheric disturbances, to the delivery point.

Features described in relation to one embodiment of the invention could used in association with features of other embodiments. For example, although the use of a four-fibre bundle wavefront sensing apparatus 100 as shown in FIG. 1 has been discussed in detail in relation to a fibre-bundle laser systems 400, 500, it will be appreciated that the other sensor systems described could be used. In particular, the seven-fibre bundle wavefront sensing apparatus shown in FIG. 3 could be used, or the scanning wavefront sensing apparatus 200, 300 shown in FIGS. 4 and 6 could be used in place of the four-fibre bundle wavefront sensing apparatus 100, without departing from the scope of the invention.

The scanning wavefront sensor could use a scanned mirror as in FIG. 4, rotating wedges as in FIG. 6, or alternatively the combined beam could be fixed and the detector assembly moved or scanned within the combined beam (i.e. scanning could be achieved in various ways by moving or scanning a detector relative the beam).

Other combinations of features described and equivalents thereof will be apparent to the person skilled in the art.

1. A method of wavefront sensing comprising the steps of
(i) combining first and second beams of radiation, said beams having a mutual frequency difference, to produce a combined beam;
(ii) detecting the combined beam at each of a plurality of positions thereacross to produce a corresponding plurality of heterodyne signals; and
(iii) measuring the phase of each of the heterodyne signals to provide corresponding phase measurements,
wherein the method further comprises the step of determining relative tip and tilt phase parameters of the wavefronts of the first and second beams at one or more positions across the combined beam from the phase measurements.

2. A method according to claim 1 wherein the method further comprises the step of determining the relative piston phase parameter of the wavefronts of the first and second beams at one or more positions across the combined beam from the phase measurements.

3. A method according to claim 1 which is a method of wavefront sensing of a fibre-bundle laser system.

4. A method according to claim 3 which is carried out for each output fibre of the fibre-bundle laser system.

5. A method according to claim 3 which further comprises determining the relative piston, tip and tilt phase parameters of an input beam having an input wavefront and an output beam having the output wavefront of the fibre-bundle laser system and controlling an actuation means associated with each output fibre in response to input of the determined relative phase parameters such that the form of the output wavefront tends to approach that of the input wavefront, or that of a wavefront having phase parameters differing by desired values from corresponding phase parameters of the input wavefront.

6. A method according to claim 1 wherein the method further comprises the step of determining the relative radius of curvature phase parameter of the wavefronts of the first and second beams at one or more positions across the combined beam from the phase measurements.

7. A method of wavefront sensing according to claim 1 wherein the first beam has a plane wavefront and said relative phase parameters are determined by fitting the phase measurements to an assumed functional form for the phase of the wavefront of the second beam.

8. A method of wavefront sensing according to claim 7 wherein the combined beam is detected at each of said plurality of positions serially by scanning the combined beam over a fixed detection position, or by scanning a detection means relative to the combined beam.

9. A method of wavefront sensing according to claim 8 wherein the combined beam is scanned over the fixed detection position by one of (i) reflecting the combined beam from a reflective element and scanning the orientation of the reflective element or (ii) passing the combined beam through a pair of rotatable, transparent wedges, the wedges having orthogonal wedge angles.

10. (canceled)

11. A method according to claim 8 wherein the combined beam is scanned over the fixed detection position such that in a plane normal to the combined beam and containing the fixed detection position the Cartesian coordinates of the centre of the combined beam as a function of time have the form
$$x = \frac{r}{2} [ cos ( 2 πυ t ) + cos ( π - 2 π n υ t ) ] ;$$
$$y = \frac{r}{2} [ sin ( 2 π υ t ) + sin ( π - 2 π n υ t ) ]$$
x=0, y=0 being the position of the fixed detection position and n being an integer.

12. A method of wavefront sensing according to claim 7 wherein said positions lie in a plane substantially normal to the combined beam and have Cartesian coordinates (0, 0), (0,a), (a\sqrt{3}/2,a/2) and (−a\sqrt{3}/2,a/2) in said plane, where a is a constant, preferably the diameter of an optical fibre and (0,0) is the centre of the combined beam.

13. A method of wavefront sensing according to claim 12 wherein the combined beam is additionally detected at positions in said plane having Cartesian coordinates (0, −a), (a\sqrt{3}/2,a/2) and (−a\sqrt{3}/2,a/2) in said plane.

14. A method of wavefront sensing according to claim 12 wherein the combined beam is detected at each of said plurality of positions across the combined beam simultaneously.

15. Wavefront sensing apparatus comprising:
(i) means for combining first and second beams of radiation, said beams having a mutual frequency difference, to produce a combined beam;
(ii) detection means arranged to detect the combined beam at each of a plurality of positions thereacross and to produce a corresponding series of heterodyne signals;
(iii) means for extracting the phase of each of the heterodyne signals to provide corresponding phase measurements;
wherein the apparatus further comprises processing means arranged to determine relative tip and tilt phase parameters of the wavefronts of the first and second beams at one or more positions across the combined beam in response to input of the phase measurements.

16. Wavefront sensing apparatus according to claim 14 wherein the processing means is arranged to determine at least one of (i) the relative piston phase parameter of the of the wavefronts of the first and second beams at one or more positions across the combined beam in response to input of the phase measurements, (ii) the relative radius of curvature phase parameter of the of the wavefronts of the first and second beams at one or more positions across the combined beam in response to input of the phase measurements.

17. (canceled)

18. Wavefront sensing apparatus according to claim 15 wherein the processing means is arranged to fit the phase measurements to an assumed functional form for the phase of the wavefront of the second beam as a function of position, in cases where the wavefront of the first beam is a plane wavefront, to determine said relative phase parameters.

19. Wavefront-sensing apparatus according to claim 18 wherein the apparatus further comprises scanning means for scanning the combined beam over a fixed detection point, or by scanning the detection means relative to the combined beam.

20. Wavefront-sensing apparatus according to claim 19 wherein the scanning means comprises one of: (i) a reflective element and means for scanning the orientation of the reflective element, (ii) first and second rotatable transparent wedges having orthogonal wedges angles, said wedges being arranged for transmission of the combined beam in use of the apparatus.

21-22. (canceled)

23. Wavefront sensing apparatus according to claim 18 wherein the detection means comprises four optical fibres, each optical fibre having one end-face located in a plane, the cores of the optical fibres having positions in the plane with relative Cartesian coordinates (0, 0), (0, a), (a\sqrt{3}/2,−a/2) and (−a\sqrt{3}/2,−a/2) where a is the diameter of the optical fibres.

24. Wavefront-sensing apparatus according to claim 23 wherein the detection means comprises seven optical fibres, each optical fibre having one end-face located in a plane, the cores of the optical fibres having positions in the plane having relative Cartesian coordinates (0, 0), (0, a), (a\sqrt{3}/2,−a/2) , (−a\sqrt{3}/2,−a/2), (0, −a), (a\sqrt{3}/2,a/2) and (−a\sqrt{3}/2,a/2) where a is the diameter of the optical fibres.

25. A fibre-bundle laser system comprising
(i) a plurality of output optical fibres, each output optical fibre having an associated lens element arranged for transmission of radiation output therefrom; and
(ii) actuation means arranged to displace any given output optical fibre with respect to its associated lens element in a plane substantially normal to the direction of radiation output from the output optical fibre,
wherein said laser system further comprises wavefront-sensing apparatus according to claim 15 and arranged determine the relative piston, tip and tilt phase parameters of a first beam having an input wavefront and second beam having the output wavefront of the system and wherein the system further comprises a feedback loop to control the actuation means in response to input of the determined relative phase parameters such that in operation of the system the form of the output wavefront tends to approach that of the input wavefront, or that of a wavefront having phase parameters differing by desired values from corresponding phase parameters of the input wavefront.

26. A fibre-bundle laser system according to claim 25 wherein the feedback loop comprises means arranged to adjust the piston phases of the radiation output from the output optical fibres according to a relative piston phase parameter derived by the wavefront-sensing apparatus such that in use of the system the form of the output wavefront tends to approach that of the input wavefront.

27. A fibre-bundle laser system according to claim 26 wherein the means arranged to adjust the piston phases of the radiation output from the output optical fibres comprises means for stretching the output optical fibres.
